(19) United States
(12) Patent Application Publication
(10) Pub. No.: US 2015/0178988 A1
(43) Pub. Date: Jun. 25, 2015

(54) METHOD AND A SYSTEM FOR GENERATING A REALISTIC 3D RECONSTRUCTION MODEL FOR AN OBJECT OR BEING

(71) Applicant: Telefonica, S.A., Madrid (ES)

(72) Inventors: Tomas Montserrat Mora, Madrid (ES); Juien Quelen, Madrid (ES); Oscar Divorra Escoda, Madrid (ES); Christian Ferran Bernstrom, Madrid (ES); Rafael Pages Scasso, Madrid (ES); Daniel Berjon Diez, Madrid (ES); Sergio Arnaldo Duart, Madrid (ES); Francisco Moran Burgos, Madrid (ES)

(73) Assignee: Telefonica, S.A., Madrid (ES)

(21) Appl. No.: 14/402,999

(22) PCT Filed: May 13, 2013
(86) PCT No.: PCT/EP2013/059827

§ 371 Date: Nov. 21, 2014

(30) Foreign Application Priority Data
May 22, 2012 (ES) P201230768

(51) Int. Cl. G06T 17/20; G06T 13/20

(52) U.S. Cl. CPC G06T 17/20; G06T 13/20

(57) ABSTRACT

A method for generating a realistic 3D reconstruction model for an object or being, comprising:
a) capturing a sequence of images of an object or being from a plurality of surrounding cameras;
b) generating a mesh of said an object or being from said sequence of images captured;
c) creating a texture atlas using the information obtained from said sequence of images captured of said object or being;
d) deforming said generated mesh according to higher accuracy meshes of critical areas;and
e) rigging said mesh using an articulated skeleton model and assigning bone weights to a plurality of vertices of said skeleton model; the method comprises generating said 3D reconstruction model as an articulation model further using semantic information enabling animation in a fully automatic framework.

The system is arranged to implement the method of the invention.

### FIELD OF THE ART

The present invention generally relates in a first aspect, to a method for generating a realistic 3D reconstructionmodel for an object or being, and more particularly to a method which allows the generation of a 3D model from a set of images taken from different points of view.

A second aspect of the invention relates to a system arranged to implement the method of the first aspect, for the particular case of a human 3D model and easily extendable for other kinds of models.

### PRIOR STATE OF THE ART

The creation of realistic 3D representations of people is a fundamental problem in computer graphics. This problem can be decomposed in two fundamental tasks: 3D modeling and animation. The first task includes all the processes involved to obtain an accurate 3D representation of the person's appearance, while the second one consists in introducing semantic information into the model (usually referred as rigging and skinning processes). Semantic information allows realistic deformation when the model articulations are moved. Many applications such as movies or videogames can benefit from these virtual characters. Recently, medical community is also increasingly utilizing this technology combined with motion capture systems in rehab therapies. Moreover, realistic digitalized human characters can be an asset in new web applications.

Traditionally, highly skilled artists and animators construct shape and appearance models for a digital character. Sometimes, this process can be partially alleviated using 3D scanning devices, but the provided results continue requiring user intervention for further refinement or intermediate process corrections.

On the other hand, Multi-view shape estimation systems allow generating a complete 3D object model from a set of images taken from different points of view. Several algorithms have been proposed in this field in the last two decades:

Reconstruction algorithms can be based either in the 2D or 3D domains. On the one hand, the first group searches for image correspondences to triangulate 3D positions. On the other hand, the second group directly derives a volume that projects consistently into the camera views. Image-based correspondence forms the basis for conventional stereo vision, where pairs of camera images are matched to recover a surface [9]. These methods require fusing surfaces from stereo pairs, which is susceptible to errors in the individual surface reconstruction. A volumetric approach, on the other hand, allows the inference of visibility and the integration of appearance across all camera views without image correspondence.

Visual Hull (VH) reconstruction is a popular family of shape estimation methods. These methods, usually referred as Shape-from-Silhouette (SfS), recover 3D object shape from 2D object silhouettes, so they do not depend on color or texture information. Since its first introduction in [1], different variations, representations and applications of SfS have been proposed [15]. The reconstructed 3D shape is called Visual Hull (VH), which is a maximal approximation of the object consistent with the object silhouettes. This fact prevents VH from reconstructing any existing concavities on the object surface. The accuracy of VH depends on the number and location of the cameras used to generate the input silhouettes. In general, a complex object such a human face does not yield a good shape when a small number of cameras are used to approximate the VH. Moreover, human faces possess numerous concavities, e.g. the eye sockets and the philtrum, which are impossible to reconstruct due to its inherent limitation. 4D View Solutions [10], is a French start-up bringing to market a 3D Video technology based on VH approach.

Shape estimation using SfS has many advantages. Silhouettes can be easily obtained and SfS methods generally have straightforward implementations. Moreover, many methods allow easily obtaining closed and manifold meshes, which is a requirement for numerous applications. In particular, voxel-based SfS methods are a good choice for VH generation because of the high quality output meshes obtainable through marching cubes [2] or marching tetrahedra algorithms [6]. Moreover, the degree of precision is fixed by the resolution of the volume grid, which can be adapted according to the required output resolution.

Many multi-view stereo methods exploit VH as a volume initialization:

In [3] SfS technique is combined with stereo photo-consistency in a global optimization that enforces feature constraints across multiple views. A unified approach is introduced to first reconstruct the occluding contours and left-right consistent edge contours in a scene and then incorporate these contour constraints in a global surface optimization using graph-cuts.

In [4] the multi-view stereo problem is also faced using a volumetric formulation optimized via graph-cuts algorithm. In this case the approach seeks the optimal partitioning of 3D space into two regions labeled as ‘object’ and ‘empty’ under a cost functional consisting of two terms: A term that forces the boundary between the two regions to pass through photoconsistent locations and a ballooning term that inflates the ‘object’ region. The effect of occlusion in the first term is taken into account using a robust photoconsistency metric based on normalized cross correlation, which does not assume any geometric knowledge of the object.

In [5] a combination of global and local optimization techniques is proposed to enforce both photometric and geometric consistency constraints throughout the modeling process. VH is used as a coarse approximation of the real surface. Then, photo-consistency constraints are enforced in three consecutive steps: First, the rims where the surface grazes the visual hull are identified through dynamic programming; secondly, with the rims fixed, the VH is carved using graph cuts to globally optimize the photoconsistency of the surface and recover its main features, including its concavities (which, unlike convex and saddle-shape parts of the surface, are not captured by the visual hull); finally, an iterative (local) refinement step is used to recover fine surface details. The first two steps allow enforcing hard geometric constraints during the global optimization process.

In [7] fusion of silhouette and texture information is performed in a snake framework. This deformable model allows defining an optimal surface which minimizes a global energy function. The energy function is posed as the sum of three terms: one term related to the texture of the object, a second term related to silhouettes and a third term which imposes regularization over the surface model.

In [8] initial shape estimation is generated by means of a voxel-based SfS technique. The explicit VH surface is obtained using MC [2]. The best-viewing cameras are then selected for each point vertex on the object initial explicit surface. Next, these cameras are used to perform a correspondence search based on image correlation which generates a cloud of 3D points. Points resulting of unreliable matches are removed using a Parzen-window-based nonparametric density estimation method. A fast implicit distance function-based region growing method is then employed to extract an initial shape estimation based on these 3D points. Next, an explicit surface evolution is conducted to recover the finer geometry details of the recovered shape. The recovered shape is further improved by several iterations between depth estimation and shape reconstruction, similar to the Expectation Maximization (EM) approach.

All the methods previously described are considered passive, as they only use the information contained in the images of the scene ([9] gives an excellent review of the state of the art in this area). Active methods, as opposed to passive, use a controlled source of light such as a laser [13] or coded light [14] in order to recover the 3D information.

If it is found that in a point of the process, the 3D information obtained from different methods yielding different polygonal resolutions needs to be merged into just one model, it would be necessary to use an additional algorithm. To accomplish this task with a good result there are mainly two different approaches.

The first one is based cutting the important area in the low polygonal resolution mesh, and later substitute it with the same section in the high resolution mesh. This technique seems to be the easiest one but, normally, some holes appear in the pasting step, so therefore, it is necessary a sewing stage to remove these holes. Among the techniques to fill these possible holes, there are several proposals. It is possible to use Moving Least Squares projections [21] to repair big non-planar holes, or it can be added robustness to this method if, after adding the approximate triangles, a re-position of the vertices by solving the Poisson equation based on the desirable normal and the boundary vertices of the hole [23] is done. In other approaches, it can be used an interpolation based on radial basis followed by a regularized marching tetrahedral algorithm and feature enhancement process [22] to recover missing detail information as sharp edges, but this is always a computationally expensive to fill holes.

The second approach is based on combining both meshes using the topological information without cutting and sewing. This is called editing or merging different meshes and there is a huge amount of literature about it. There many ways to edit a mesh based on different criteria: Free-form deformation (FFD) can be point-based or curve-based. Additionally,in a scenario where two different meshes have to be merged, another suitable algorithm is presented in [24] which is also based in the Poisson equation and in modifying the mesh with a gradient field manipulation. However, this approach needs at least a small amount of user interactions, so it is not optimal for an automatic system.

Once the mesh structure has been recovered, semantic information must be added to the model in order to make its animation possible. Model animation is usually carried out considering joint angle changes as the measures to characterize human pose changing and gross motion. This means that poses can be defined by joint angles. By defining poses and motion in such a way, the body shape variations caused by pose changing and motion will consist of both rigid and non-rigid deformation. Rigid deformation is associated with the orientation and position of segments that connect joints. Non-rigid deformation is related to the changes in shape of soft tissues associated with segments in motion, which, however, excludes local deformation caused by muscle action alone. The most common method for measuring and defining joint angles is using a skeleton model. In the model, the human body is divided into multiple segments according to major joints of the body, each segment is represented by a rigid linkage, and an appropriate joint is placed between the two corresponding linkages. The main advantage of pose deformation is that it can be transferred from one person to another.

The animation of the subject can also be realized by displaying a series of human shape models for a prescribed sequence of poses.

In [11] a framework is built to construct functional animated models from the captured surface shape of real objects. Generic functional models are fitted to the captured measurements of 3D objects with complex shape. Their general framework can be applied for animation of 3D surface data captured from either active sensors or multiple view images.

A layered representation is reconstructed composed of a skeleton, control model and displacement map. The control model is manipulated via the skeleton to produce non-rigid mesh deformation using techniques widely used in animation. High-resolution captured surface detail is represented using a displacement map from the control model surface. This structure enables seamless and efficient animation of highly detailed captured object surfaces. The following tasks are performed:
Shape constrained fitting of a generic control model to approximate the captured data.
Automatic mapping of the high-resolution data to the control model surface based on the normal-volume is used to parameterize the captured data. This parameterization is then used to generate a displacement map representation. The displacement map provides a representation of the captured surface detail which can be adaptively resampled to generate animated models at multiple levels-of-detail.
Automatic control model generation for previously unmodelled objects. A mesh simplification algorithm is used to produce control models from the captured 3D surface. The control models produced are guaranteed to be injective with the captured data enabling displacement mapping without loss of accuracy using the normal-volume.

The framework enables rapid transformation of 3D surface measurement data of real objects into a structured representation for realistic animation. Manual interaction is required to initially align the generic control model or define constraints for remeshing of previously unmodelled objects. Then, the system enables automatic construction of a layered shape representation.

In [3] a unified system is presented for capturing a human's motion as well as shape and appearance. The system uses multiple video cameras to create realistic animated content from an actor's performance in full wardrobe. The shape is reconstructed by means of a multi-view stereo method (previously described in this section).

A time-varying sequence of triangulated surface meshes is initially provided. In this first stage, surface sampling, geometry, topology, and mesh connectivity change at each time frame for a 3D object. This unstructured representation is transformed to a single consistent mesh structure such that the mesh topology and connectivity is fixed, and only the geometry and a unified texture change over time. To achieve this, each mesh is mapped onto the spherical domain and remeshed as a fixed subdivision sphere. The mesh geometry is expressed as a single time-varying vertex buffer with a predefined overhead (vertex connectivity remains constant). Character animation is supported, but conventional motion capture for skeletal motion synthesis cannot be reused in this framework (similar to [16] This implies the actor is required, at least, to perform a series of predefined motions (such as walking, jogging, and running) that form the building blocks for animation synthesis or, eventually, perform the full animation to synthesize.

In [12] the authors present a framework to generate high quality animations of scanned human characters from input motion data. The method is purely mesh-based and can easily transfer motions between human subjects of completely different shape and proportions. The standard motion capture sequence, which is composed of key body poses, is transformed into a sequence of postures of a simple triangle mesh model. This process is performed using standard animation software which uses a skeleton to deform a biped mesh. The core of the approach is an algorithm to transfer motion from the moving template mesh onto the scanned body mesh. The motion transfer problem is formulated as a deformation transfer problem. Therefore, a sparse set of triangle correspondences between the template and the target mesh needs to be manually specified. Then, the deformation interpolation method automatically animates the target mesh. The resulting animation is represented as a set of meshes instead of a single rigged mesh and its motion.

Problems with existing solutions:

In general, current solutions do not provide visually accurate model reconstructions with semantic information in a fully automatic framework. On the one hand, mesh and texture information must be generated. Some systems focus on mesh reconstruction and then rely on view dependent texturing [15]. This is a valid option in some environments (e.g. free viewpoint video), but CAD applications and rendering engines commonly require a unified texture atlas. On the other hand, semantic information is required in order to control articulations using skeletal animations and to deform the mesh surface according to body postures. This information is commonly supplied through skeleton rig and associated skinning weights bound to the mesh (rigging and skinning processes involved). Most of the systems focus either in modeling and texturing the mesh or in the animation task, so frequently manual intervention is required in order to adapt the results of the first part of the pipeline to the requirements imposed by the second one.

For a 3D model which is intended to be animated (or simply 3D printed) mesh accuracy is a requirement but also topological correctness of the mesh must be taken into account. Topological correctness (closed 2-manifold) is a requirement for the mesh to ensure compatibility with the widest range of applications.

Laser scanner devices [13] or coded light systems [14] can provide a very accurate surface in form of a polygonal mesh with hundred thousand of faces but very little semantic information. Usually the step between partial area scanned data and the final complete (and topologically correct) mesh requires manual intervention. Moreover, an additional large degree of skill and manual intervention is also required to construct a completely animatable model (rigging and skinning processes). The scanning process of the full body can take around 17 seconds to complete for a laser device [13]. This amount of time requires the use of 3D motion compensation algorithms as it is difficult for the user to remain still during the entire process. However these algorithms increase the system complexity and can introduce errors in the final reconstruction.

Highly realistic human animation can be achieved by animating the laser scanned human body with realistic motions and surface deformations. However, the gap between the static scanned data and animation models is usually filled with manual intervention.

Visual Hull surfaces can be generated by means of different SfS algorithms [10]. Nevertheless, surface concavities are not reconstructed by SfS solutions. This fact prevents these solutions from being suitable to reconstruct complex areas such as human face.

Regarding to mesh reconstruction, passive multi-view algorithms ([3] [4] [5] [7] [8]) also yield less accurate results than active systems (laser or structured light based). Common problems/challenges for passive systems are listed below:
Uniform appearance. Extended areas of uniform appearance for skin and clothing limit the image variation to accurately match between camera views to recover surface shape.
Self occlusions. Articulation leads to self-occlusions that make matching ambiguous with multiple depths per pixel, depth discontinuities, and varying visibility across views.
Sparse features. Shape reconstruction must match features such as clothing boundaries to recover appearance without discontinuities or blurring, but provide only sparse cues in reconstruction.
Specularities. Non-Lambertian surfaces such as skin cause the surface appearance to change between camera views, making image matching ambiguous.

Over-carving is also a typical problem in multi-view stereo algorithms which use VH as initialization. In some cases, as in [4] an inflationary ballooning term is incorporated to the energy function of the graph cuts to prevent over-carving, but this could still be a problem in high curvature regions.

Multi-view reconstruction solutions can provide a 3D model of the person for each captured frame of the imaging devices. Nonetheless, these models also lack of semantic information and they are not suitable to be animated in a traditional way. Some systems, like [10] [3] or [16] can provide 3D animations of characters generated as successive meshes being shown frame by frame. In this case, the 3D model can only perform the same actions the human actor has been recorded doing (or a composition of some of them), as the animation is represented as a free viewpoint video. Free viewpoint video representation of animations limits the modification and reuse of the captured scene to replaying the observed dynamics. Commonly, use cases require the 3D model to be able to perform movements captured from different people (retargeting of motion captures), which results in the need of semantic information added to the mesh. In this case, animations are generated as successive deformations of the same mesh, using a skeleton rig bound to the mesh.

The system described in [12] does not rig a skeleton model into the given mesh, neither consequently calculates skinning weights. The animation is performed transferring deformations from a template mesh to the given mesh without an underlying skeleton model, although the template mesh is deformed by means of a skinning technique (LBS). Moreover, correspondence areas between template mesh and target mesh must be manually defined.

In [11] manual registration is required. Initially, a generic control model (which includes skinning weights) must be manually posed for approximate alignment with the capture data. Also, a displacement map has to be generated in order to establish a relation between the generic model surface (which is animated) and the unstructured captured data. Despite the displacement map, the control model is only able to roughly approximate the original model.

In [3] 3D animations are created as target morphs. This implies that a deformed version of the mesh is stored as a series of vertex positions in each key frame of the animation. The vertex positions can also be interpolated between key frames. The system can produce new content, but needs to record a performance library from an actor and construct a move tree for interactive character control (motion segments are concatenated). Content captured using conventional motion-capture technology for skeletal motion synthesis cannot be reused.

### DESCRIPTION OF THE INVENTION

It is necessary to offer an alternative to the state of the art which covers the gaps found therein, particularly related to the lack of proposals which really allow to provide a visual accurate model reconstruction with semantic information in a fully automatic framework.

To that end, the present invention provides, in a first aspect, a method for generating a realistic 3D reconstruction model for an object or being. The method comprising:

a) capturing a sequence of images of an object or being from a plurality of surrounding cameras;

b) generating a mesh of said an object or being from said sequence of images captured;

c) creating a texture atlas using the information obtained from said sequence of images captured of said object or being;

d) deforming said generated mesh according to higher accuracy meshes of critical areas;and

e) rigging said mesh using an articulated skeleton model and assigning bone weights to a plurality of vertices of said skeleton model;

The method generating said 3D reconstruction model as an articulation model further using semantic information enabling animation in a fully automatic framework.

The method further comprises applying a closed and manifold Visual Hull (VH) mesh generated by means of Shape from Silhouette techniques, and applying multi-view stereo methods for representing critical areas of the human body.

In a preferred embodiment, the model used is a closed and manifold mesh generated by means of at least one of a: Shape from Silhouette techniques, Shape from Structured light techniques, Shape from Shading, Shape from Motion or any total or partial combination thereof.

Other embodiments of the method of the first aspect of the invention are described according to appended claims 2 to 18, and in a subsequent section related to the detailed description of several embodiments.

A second aspect of the present invention concerns to a system for generating a realistic 3D reconstruction model for an object or being, the system comprising:

a capture room equipped with a plurality of cameras surrounding an object or being to be scanned; and

a plurality of capture servers for storing images of said object or being from said plurality of cameras,

The system is arrange for using said images of said object or being scanned for fully automatically generate said 3D reconstruction model as an articulation model.

The system of the second aspect of the invention is adapted to implement the method of the first aspect.

Other embodiments of the system of the second aspect of the invention are described according to appended claims 19 to 24, and in a subsequent section related to the detailed description of several embodiments.

### BRIEF DESCRIPTION OF THE DRAWINGS

The previous and other advantages and features will be more fully understood from the following detailed description of embodiments, with reference to the attached drawings, which must be considered in an illustrative and non-limiting manner, in which:

FIG. 1 shows the general block diagram related to this invention.

FIG. 2 shows the block diagram when using a structured light, according to an embodiment of the present invention.

FIG. 3 shows an example of a simplified 2D version of the VH concept.

FIG. 4 shows the block diagram when not using a structured light, according to an embodiment of the present invention.

FIG. 5 shows an example of the shape from silhouette concept.

FIG. 6 shows the relationship between the camera rotation and the “z” vector angle in the camera plane.

FIG. 7 shows some examples of the correct shadow removal, according to an embodiment of the present invention.

FIG. 8 shows the volumetric Visual Hull results, according to an embodiment of the present invention.

FIG. 9 shows the Visual Hull mesh after smoothing and decimation processes, according to an embodiment of the present invention.

FIG. 10 illustrates how the position of a 3D point is recovered from its projections in two images.

FIG. 11, shows a depth map with its corresponding reference image and the partial mesh recovered from that viewpoint.

FIG. 12, illustrates an example of a Frontal high accuracy mesh superposed to a lower density VH mesh.

FIG. 13, represents the Algorithm schematic diagram, according to an embodiment of the present invention.

FIG. 14, illustrates an example on how the Vertices are moved through the line from d-barycenter, to the intersection with facial mask mesh.

FIG. 15, illustrates the calculating the distance from MOVED and STUCK vertices.

FIG. 16, show the results before and alter the final smoothing process, according to an embodiment of the present invention.

FIG. 17, shows two examples of input images and the results after pre-processing them.

FIG. 18, shows texture improvement by using image pre-processing, according to an embodiment of the present invention.

FIG. 19, shows the improved areas using the pre-processing step in detail, according to an embodiment of the present invention.

FIG. 20, shows the results after texturing the 3D mesh, according to an embodiment of the present invention.

FIG. 21, shows an example of texture atlas generated with the method of the present invention.

FIG. 22 shows the subject in the capture room (known pose), the mesh with the embedded skeleton and the segmentation of the mesh in different regions associated to skeleton bones.

FIG. 23, shows an example of the invention flow chart.

FIG. 24, shows an example of the invention data flow chart.

### DETAILED DESCRIPTION OF SEVERAL EMBODIMENTS

This invention proposes a robust and novel method and system to fully automatically generate a realistic 3D reconstruction of a human model (easily extendable for other kinds of models).

The process includes mesh generation, texture atlas creation, texture mapping, rigging and skinning. The resulting model is able to be animated using a standard animation engine, which allows using it in a wide range of applications, including movies or videogames.

The mesh modelling step relies on Shape from Silhouette (SfS) in order to generate a closed and topologically correct (2-manifold) Visual Hull (VH) mesh which can be correctly animated. VH also provides a good global approximation of the structure of hair, a problematic area for most of the current 3D reconstruction systems.

This modelling technique provides good results for most of human body parts. However, some critical areas for human perception, such as face, require higher accuracy in the mesh sculpting process. The system solves this problem by means of a local mesh reconstruction strategy. The invention approach uses multi-view stereo techniques to generate highly accurate local meshes which are then merged in the global mesh preserving its topology.

A texture atlas containing information for all the triangles in the mesh is generated using the colour information provided by several cameras surrounding the object. This process consists of unwrapping the 3D mesh to form a set of 2D patches. Then, these patches are packed and efficiently arranged over the texture image. Each pixel in the image belonging to at least one patch is assigned to a unique triangle of the mesh. The colour of a pixel is determined by means of a weighted average of its colour in different surrounding images. The position of a pixel in surrounding views is given by the position of the projection of the 3D triangle it belongs to. Several factors can be taken into account apart from visibility in order to find the averaging weight of each view.

The invention texture-recovery process differs from current techniques for free-viewpoint rendering of human performance, which typically use the original video images as texture maps in a process termed view-dependent texturing. View-dependent texturing uses a subset of cameras that are closest to the virtual camera as textured images, with a weight defined according to the cameras' relative distance to the virtual viewpoint. By using the original camera images, this can retain the highest-resolution appearance in the representation and incorporate view dependent lighting effects such as surface specularity. View-dependent rendering is often used in vision research to overcome problems in surface reconstruction by reproducing the change in surface appearance that's sampled in the original camera images. The whole mesh modelling and texturing process emphasizes on visual rather than metric accuracy.

The mesh is also rigged using an articulated human skeleton model and bone weights are assigned to each vertex. These processes allow performing real time deformation of the polygon mesh by way of associated bones/joints of the articulated skeleton. Each joint includes a specific rigidity model in order to achieve realistic deformations.

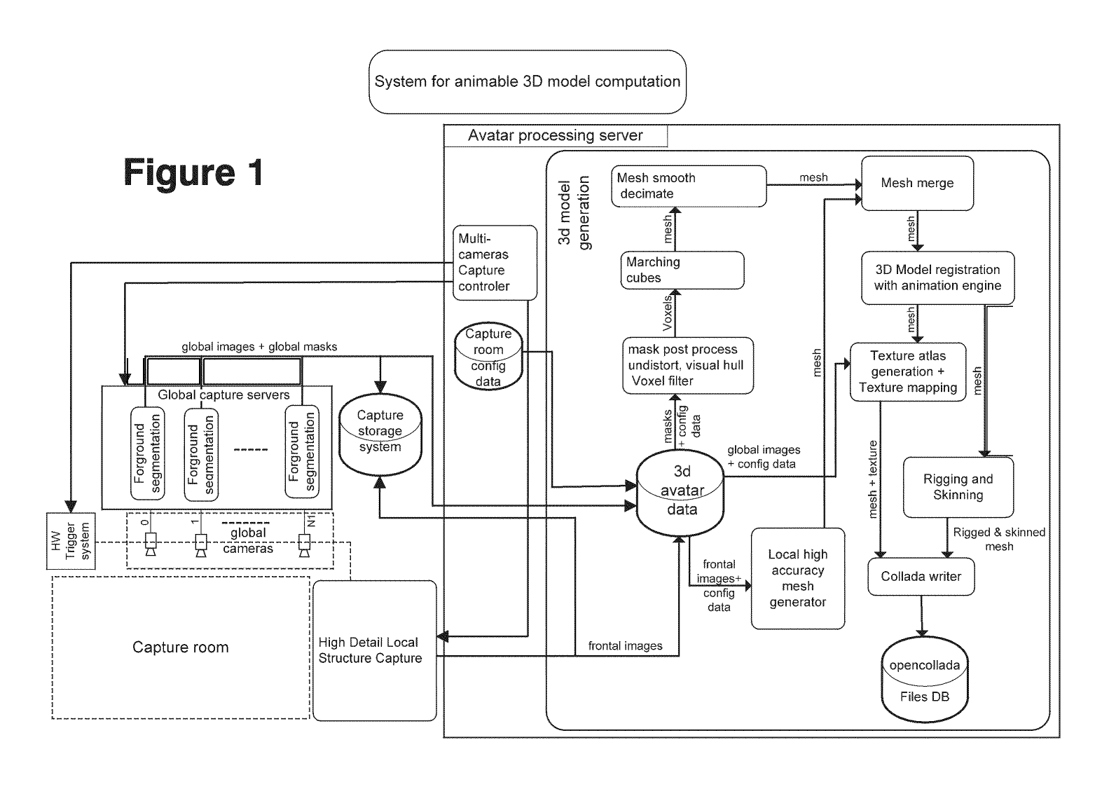

FIG. 1 shows the general block diagram related to the system presented in this invention. It basically shows the connectivity between the different functional modules that carry out the 3D avatar generation process. See section 3 for a detailed description of each one of these modules.

The system of the present invention relies on a volumetric approach of SfS technique, which combined with the Marching Cubes algorithm, provides a closed and manifold mesh of the subject's VH. The topology of the mesh (closed and manifold) makes it suitable for animation purposes in a wide range of applications. Critical areas for human perception, such as face, are enhanced by means of local (active or passive) stereo reconstruction. The enhancement process uses a local high density mesh (without topological restrictions) or a dense point cloud resulting from the stereo reconstruction to deform the VH mesh in a process referred to as mesh fusion. The fused/merged mesh retains the topology correctness of the initial VH mesh. At this point, a texture atlas is generated from multiple views. The resulting texture allows view-independent texturing and it is visually correct even in inaccurate zones of the volume (if exist). Additionally, the mesh is rigged using a human skeleton and skinning weights are calculated for each triangle, allowing skeletal animation of the resulting model. All the model information is stored in a format compatible with common 3D CAD or rendering applications such as COLLADA.

The proposed system requires a capture room equipped with a set of cameras surrounding the person to be scanned. These cameras must be previously calibrated in a common reference frame. This implies to retrieve their intrinsic parameters (focal distance, principal point, lens distortion), which model each camera sensor and lens properties, as well as their extrinsic parameters (projection center and rotation matrix), which indicate the geometrical position of each camera in an external reference frame. These parameters are required by the system to reconstruct the 3D geometry of the observed scene. An example of a suitable calibration technique is described in [17]

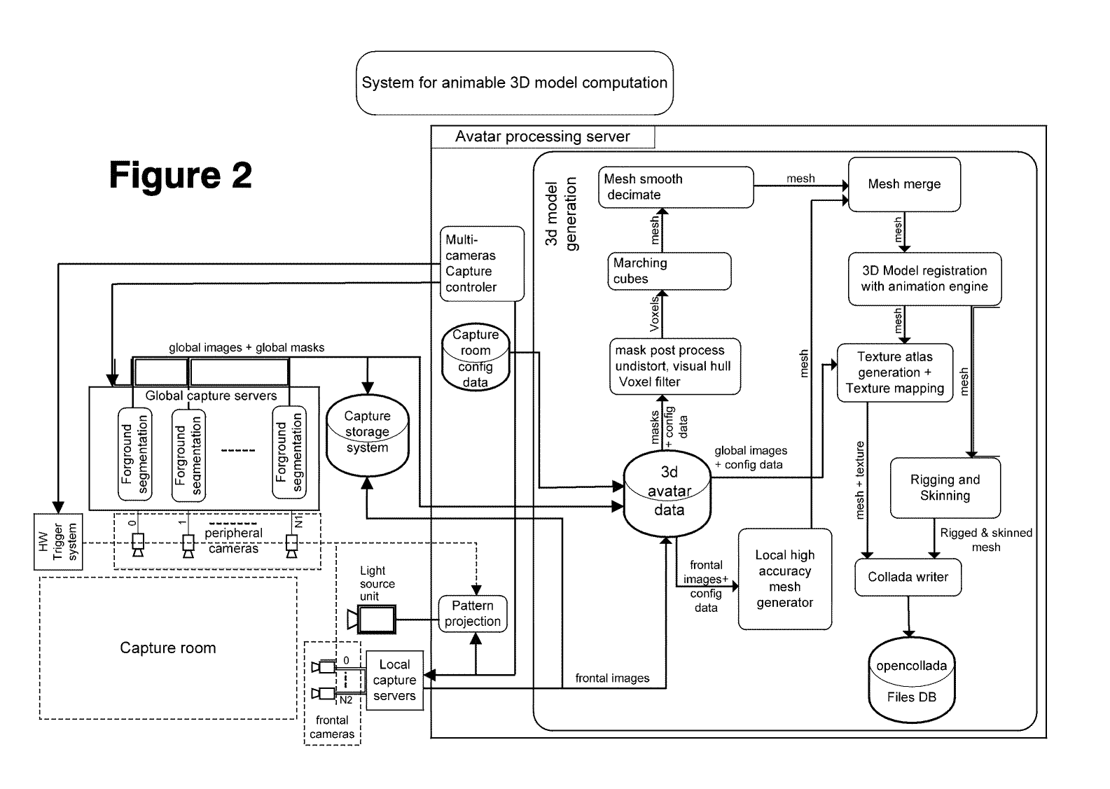

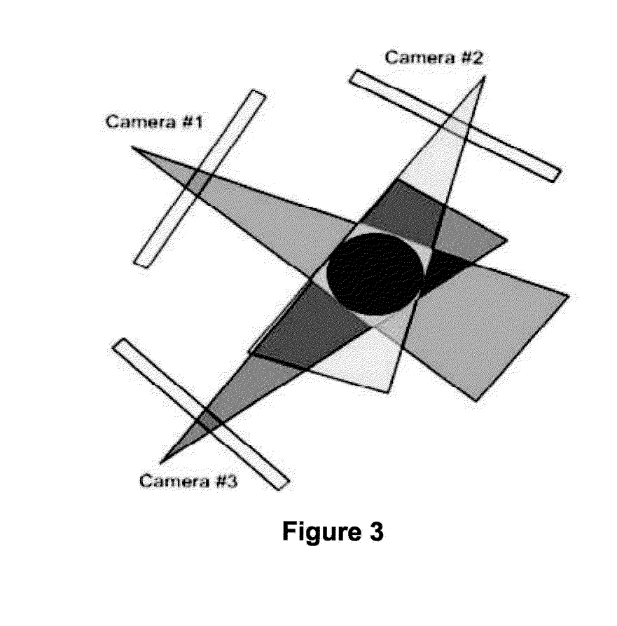

In the system block diagram presented in FIG. 2 two types of cameras can be seen: peripheral and local (or frontal) cameras. On the one hand, peripheral cameras are distributed around the whole room. These cameras are intended to reconstruct the Visual Hull of the scanned user. As previously said, Visual Hull is defined as the intersection of silhouette cones from 2D camera views, which capture all geometric information given by the image silhouettes. No special placement constraints are imposed for peripheral cameras beyond their distribution around the subject. Also these cameras are not required to see the whole person. Depending on the number of available cameras, the placement and the areaseen by each one can be tuned to improve the results, as the accuracy of the reconstruction is limited by the number and the position of cameras. The scanning position of the subject is also a factor to take into account in order to avoid artifacts as phantom parts. These phantom parts are the result of using a finite number of cameras, which prevents capturing the object at every angle. This leads to assign to the reconstructed object the spatial zones without sufficient information to determine if they belong or not to it. Generally, a number around 20 peripheral cameras should be a good trade-off between resources and accuracy. FIG. 3 shows a simplified 2D version of the VH concept; there, the circular object in red is reconstructed as a pentagon due to the limited number of views. The zones in bright green surrounding the red circle are phantom parts which cannot be removed from the VH as they are consistent with the silhouettes in all three views.

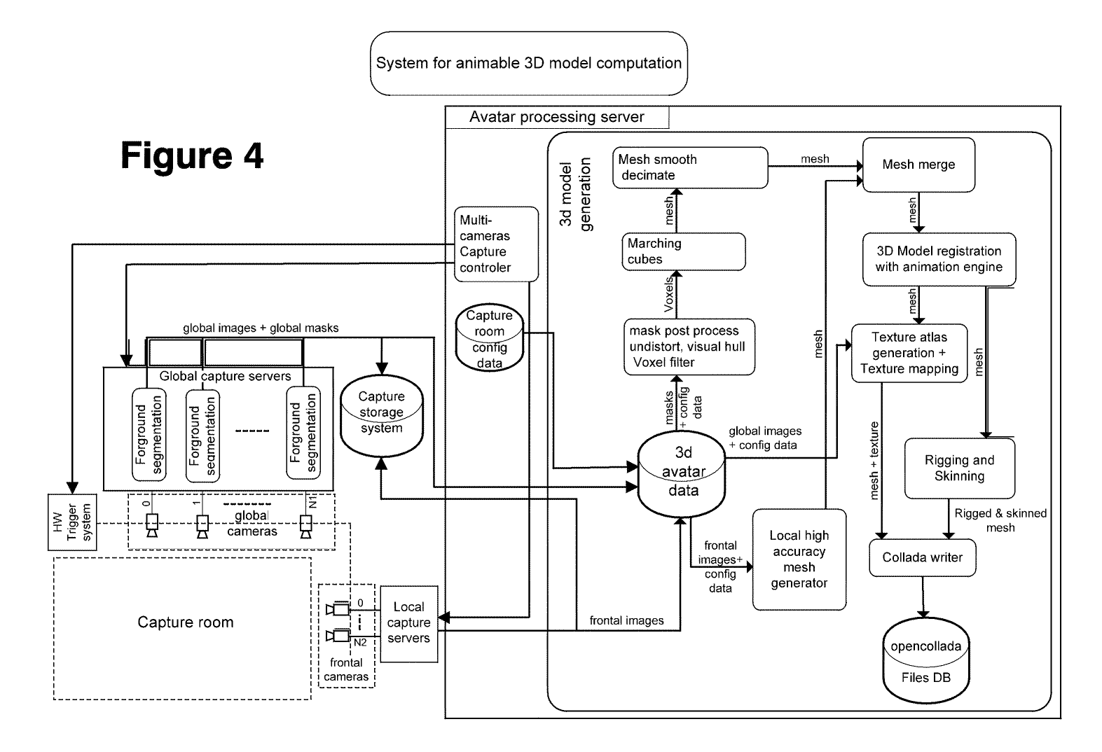

On the other hand, frontal (or local) cameras are intended to be used in a stereo reconstruction system to enhance the mesh quality in critical areas such as face, where VH inability to cope with concavities represents a problem. As stated before, stereo reconstruction systems estimate depth for each pixel of a reference image by finding correspondences between images captured from slightly different points of view. FIG. 1 uses the concept of “High Detail Local Structure Capture” system to represent more generally the second type of cameras employed. This concept encloses the idea that high detail reconstruction for reduced areas can be carried out by means of different configurations or algorithms. FIG. 2 represents a system using structured light to assist the stereo matching process (active stereo), while FIG. 4 shows the same system without structured light assistance (passive stereo). In each case, camera requirements can change significantly. Firstly, a common requirement for all the embodiments is that local and peripheral cameras are synchronized using a common trigger source. In the case of passive stereo reconstruction, only one frame per camera is required (same as in SfS). However, structured light systems usually require several images captured under the projection of different patterns. In this scenario, it is convenient having a reduced capture time for the full pattern sequence in order to reduce chances of user movement. A higher frame rate for frontal cameras can be obtained by using a local trigger which is a multiple of the general one. This allows using less expensive cameras for peripheral capture. Also a synchronization method is required between frontal cameras and the structured light source. The trigger system is referred as “Hardware Trigger System” in figures and its connectivity is represented as a dotted line. Secondly, frontal cameras resolution should be higher in critical areas than the resolution provided by peripheral cameras. In a passive stereo system, at least two cameras are required for each critical area, while active systems can operate with a minimal setup composed of a camera and a calibrated light source. Calibration of the light source can be avoided by using additional cameras. The cameras/projectors composing a “High Detail Local Structure Capture” rig must have a baseline (distance between elements) limited in order to avoid excessive occlusions.

Foreground Segmentation

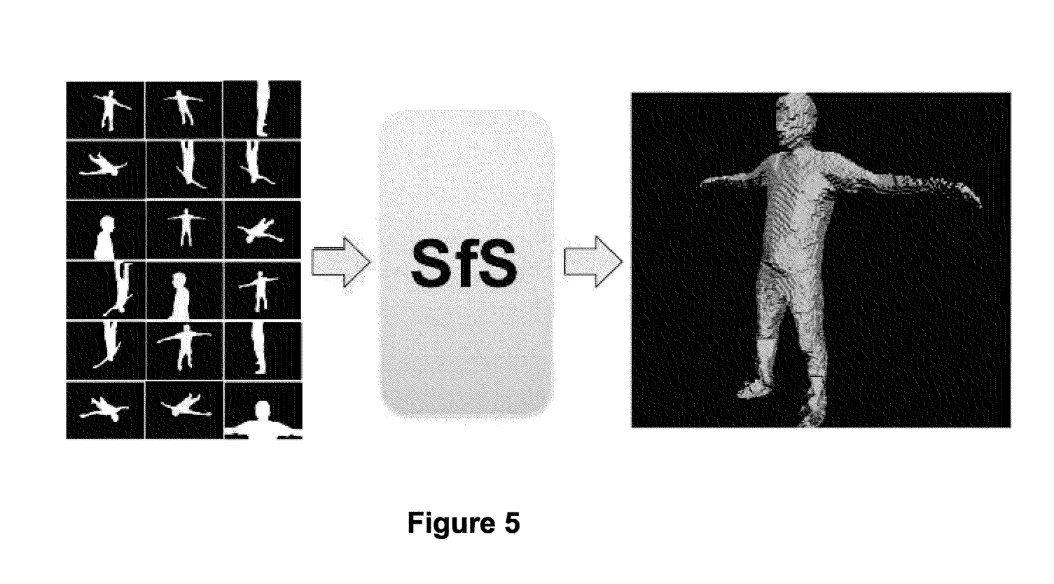

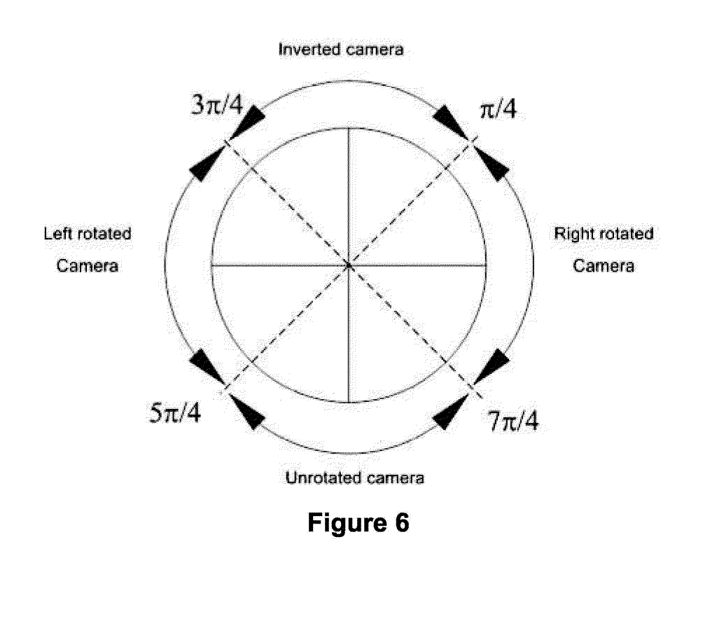

As stated before, the proposed system uses a SfS-based mesh modeling strategy. Therefore, user silhouettes are required for each peripheral camera to compute the user's Visual Hull (see FIG. 5). Different techniques exist to separate foreground from background, being blue/green-screen chroma keying the most traditional. However, advanced foreground segmentation techniques can achieve the same goal without the strong requirement of the existence of a known screen behind the user of interest. In this case, statistical models of the background (and eventually of the foreground and the shadow) are built. It is proposed to adopt one of these advanced foreground segmentation techniques constraining the shadow model in accordance to the camera calibration information which is already known (diffuse ceiling illumination is assumed).

In a particular embodiment, the approach described in [30] may be used. The solution achieves foreground segmentation and tracking combining Bayesian background, shadow and foreground modeling.

In [30] the system requires indicating manually where the shadow regions are placed related to the position of the object. The present invention overcomes this limitation using the camera calibration information. Calibration parameters are analyzed to find the normal vector to the smart room ground surface, which, in this case, corresponds to the “z” vector, the third column of the camera calibration matrix. Therefore, obtaining the projection of the 3-dimensional “z” vector with regard to the camera plane, it can be obtained the rotation configuration of the camera according to the ground position, and it will be able to locate the shadow model on the ground region, according to the object position in the room. The processing steps needed to obtain the shadow location are:
1. Load camera parameters. Obtain the “z” vector, which corresponds to the third column of the camera calibration matrix: z=(z1,z2,z3)
2. Obtain the “z” vector angle in the camera plane. It is obtained calculating:

$${tan}^{- 1} ( \frac{{z}_{2}}{{z}_{1}} )$$

3. Analyze the resultant angle to define the shadow location.

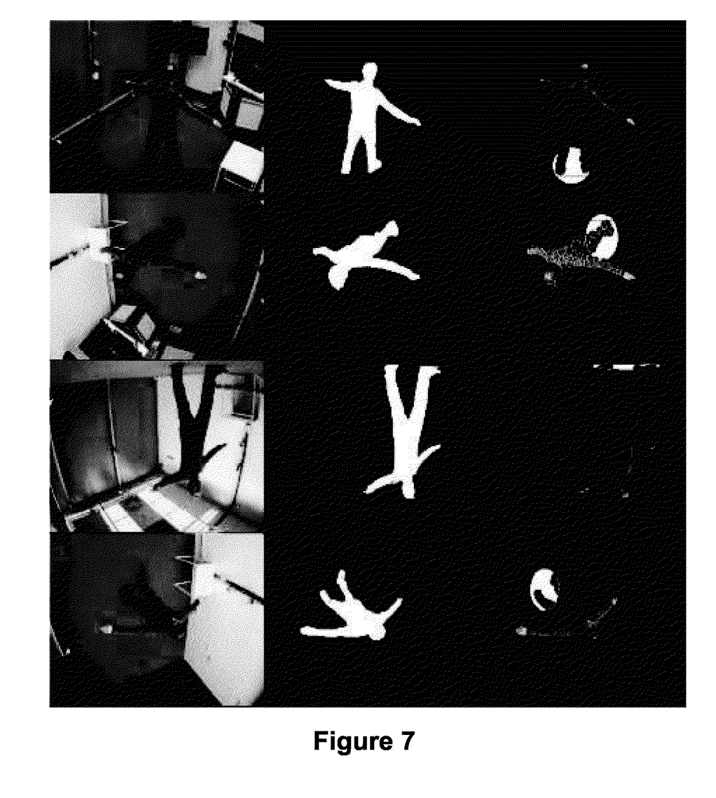

In FIG. 7 it can be observed some examples of correct shadow removal, where the shadow model (white ellipse at user's feet) is located correctly after this previous analysis.

Volumetric Shape from Silhouette

Volumetric Shape from Silhouette approach offers both simplicity and efficient implementations. It is based on the subdivision of the reconstruction volume or Volume Of Interest (VOI) into basic computational units called voxels. An independent computation determines if each voxel is inside or outside the Visual Hull. The basic method can be speeded up by using octrees, parallel implementations or GPU-based implementations. Required configuration parameters (bounding box of the reconstruction volume, calibration parameters, etc.) are included in “Capture Room Config. Data” block in system diagram figures.

Once the image silhouettes have been extracted, Visual Hull reconstruction process can be summarized as follows:
Remove lens distortion effects from silhouettes if necessary.
Discretize the volume into voxels
Check occupancy for each voxel:
   Project voxel into each silhouette image.
      If the projection is outside at least one silhouette the voxel is empty.
      If the projection is inside all silhouettes the voxel is occupied.

As peripheral cameras are not required to see the whole volume, only the cameras where the specific voxel is projected inside the image are taken into account in the projection test.

Since the occupancy test for each voxel is independent of the other voxels, the method can be parallelized easily.

The accuracy of the reconstruction is limited by voxel resolution. When using a too low spatial resolution discretization artifacts appear in the output volume, which presents aliasing effects.

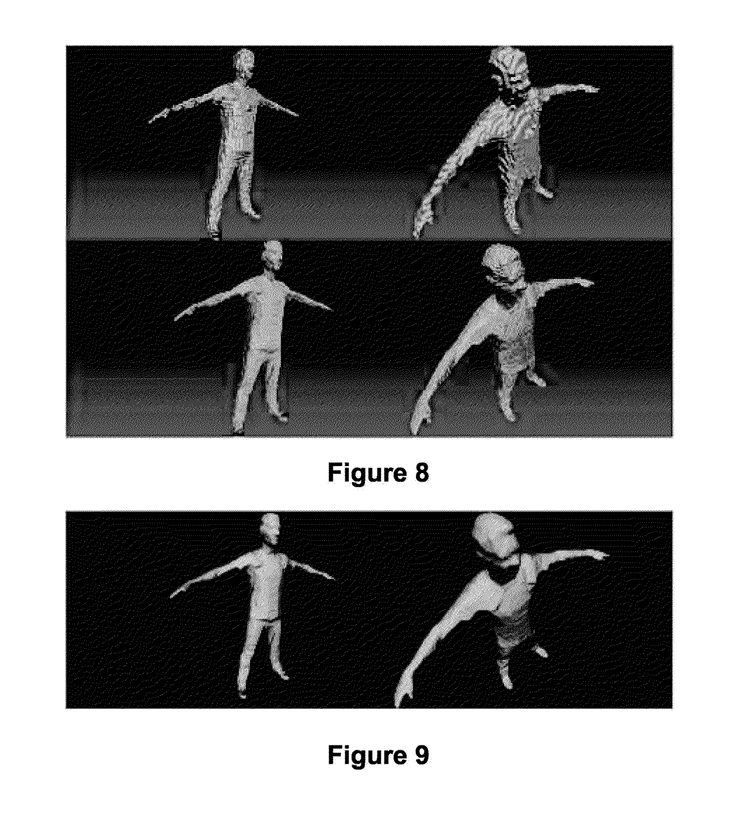

The reconstructed volume is converted into a mesh by using the Marching Cubes algorithm [2] (alternatively Marching Tetrahedra [18] could be used) (see FIG. 8). However, previously to the mesh recovering step, the voxel volume is filtered in order to remove possible errors. In one embodiment of this filtering stage, 3D morphological closing could be used.

Marching cubes stage provides a closed and manifold VH mesh which nevertheless suffers from two main problems:
1. It presents aliasing artifacts resulting from the initial volume discretization in voxels (even if high voxel resolutions are employed).
2. Its density of polygons (triangles) is too high.

In order to correct these problems keeping the mesh correct topology, two additional processing stages are included. Both of them are enclosed in the “Mesh Smooth Decimate” block of the invention diagram in FIG. 1. First, mesh smoothing removes aliasing artifacts from the VH mesh. In a particular embodiment, iterative HC Laplacian Smooth [19] filter could be used for this purpose. Once the mesh has been smoothed it can be simplified in order to reduce the number of triangles. In one embodiment, Quadric Edge Decimation can be employed [20] (see FIG. 9).

Local High Accuracy Mesh Generation

As stated before, VH can provide a full reconstruction of the user volume except for its concavities. Nonetheless, stereo reconstruction methods can accurately recover the original shape (including concavities), but they are only able to provide the so-called 2.5D range data from a single point of view. Therefore, for every pixel of a given image, stereo methods retrieve its corresponding depth value, producing the image depth map. FIG. 11 shows a depth map with its corresponding reference image and the partial mesh recovered from that viewpoint (obtaining this partial mesh from the depth map is trivial). Multiple depth maps should be fused in order to generate a complete 3D model. This requires several images to be captured from different viewing directions. Some multi-view stereo methods which carry out complex depth map fusion have been presented previously. The invention uses VH for a global reconstruction and only critical areas are enhanced using local high accuracy meshes obtained by means of stereo reconstruction methods.

Stereo reconstruction methods infer depth information from point correspondences in two or more images (see FIG. 10). In some active systems, one of the cameras may be replaced by a projector, in which case, correspondences are searched between the captured image and the projected pattern (assuming only a camera and a projector are used). In both cases, the basic principle to recover depth is the triangulation of 3D points from their correspondences in images. FIG. 10 illustrates how the position of a 3D point is recovered from its projections in two images. Passive methods usually look for correspondences relying on color similarity, so a robust metric for template matching is required. However, the lack of texture or repeated textures can produce errors. In opposite, active systems use controlled illumination of the scene making easier to find correspondences regardless the scene texture.

Camera separation is also a factor to take into account. The separation between cameras has to be a trade-off between accuracy and occlusion minimization: On the one hand, a small distance between the cameras does not give enough information for recovering 3D positions accurately. On the other hand, a wide baseline between cameras generates bigger occlusions which are difficult to interpolate from their neighborhood in further post-processing steps. This implies that generally (except when a very high number of cameras are used for VH reconstruction) an independent set of cameras (or rig) must be added for the specific task of local high accuracy mesh generation.

In a particular embodiment, a local high accuracy reconstruction rig may be composed by two cameras and a projector (see FIG. 2). Several patterns may be projected on to the model in order to encode image pixels. This pixel codification allows the system to reliably find correspondences between different views and retrieve the local mesh geometry. The method described in [26] may be used for this purpose.

In another embodiment, a local high accuracy reconstruction rig may be composed by two or more cameras (see FIG. 4), relying only in passive methods to find correspondences. The method described in [27] may be used to generate the local high accuracy mesh.

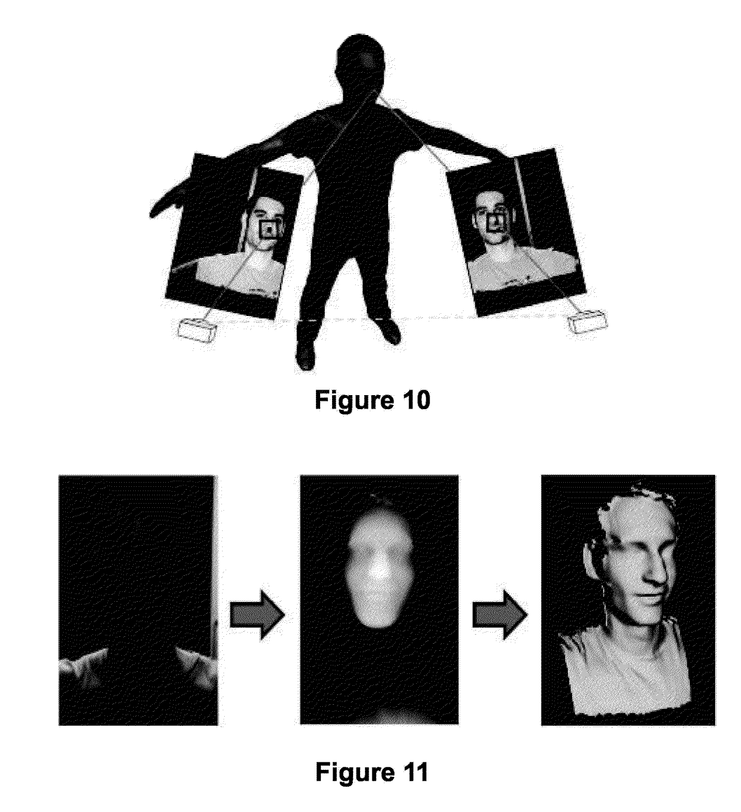

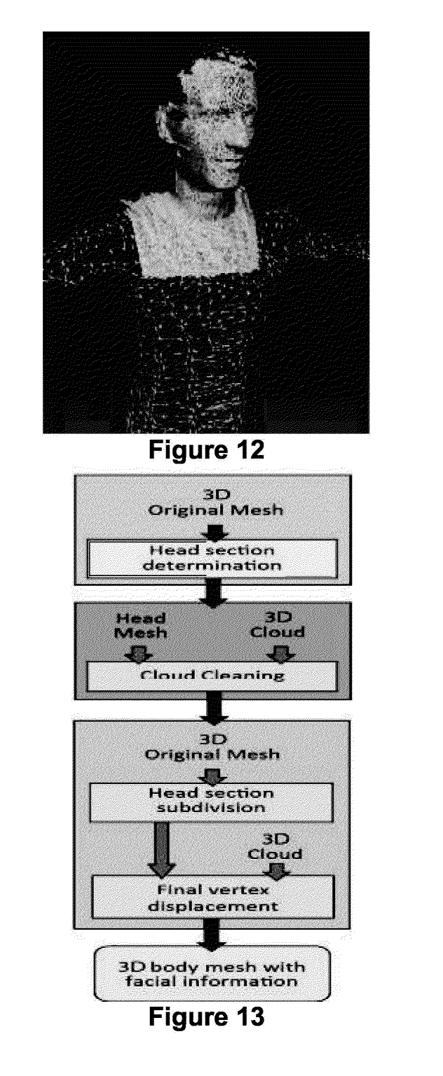

Once the depth map has been obtained, every pixel of the reference image can be assigned to a 3D position which defines a vertex in the local mesh (neighbor pixel connections can be assumed). This usually generates too dense meshes which may require further decimation in order to alleviate the computational burden in the following processing steps. In a particular embodiment, Quadric Edge Decimation can be employed [20] combined with HC Laplacian Smooth [19] filter in order to obtain smooth watertight surfaces with a reduced number of triangles (see FIG. 12).

Mesh Fusion

The 3D mesh obtained from applying Marching Cubes on the voxelized Visual Hull suffers from a lack of details. Moreover, the smoothing process the mesh undergoes in order to remove aliasing effects results in an additional loss of information, especially in the face area. Because of this, additional processing stages are required to enhance all the distinctive face features by increasing polygonal density locally. The invention system proposes the use of structured light or other active depth sensing technologies to obtain a depth map from a determined area. This depth map can be easily triangulated connecting neighboring pixels, which allows combining both the mesh from the VH and the one from the depth map.

In a particular embodiment, where the face area is enhanced, the following algorithm may perform this fusion task. The algorithm first subdivides the head section of the VH mesh to obtain a good triangle resolution. Then it moves the vertices of the face section until they it reaches the position of a depth map mesh triangle. After that, a position interpolation process is done to soften the possible abrupt transitions.

The only parameters that this algorithm needs are the high resolution facial mesh, the 3D mesh obtained from the VH and a photo of the face of the subject. Once all these arguments are read and processed, the algorithm starts. In the first step a 2D circle its obtained which determines where is the face in the photograph taken by the camera pointing at the face. With the position of this camera and the center of the circle, a line which is going to intersectin two points of the mesh is created; with these two points, the “width” of the head can be determined, and also a triangle in the mesh,called “seed”, for a lateruse, will be selected. In this step, two points called d-barycenter and t-barycenter will also be determined: these point will be situated inside the head, approximately next to the center and in the middle top part respectively. It is necessary that the t-barycenter is placed next to the top, because it will be used in the determination of the section of the mesh which represents the head of the subject.

Before starting to move vertices, it is necessary to clean the mesh obtained from the depth map (it will be called “cloud mesh” from now) to avoid the information of different body parts which are not the face, which sometimes include noise and irregularities. To do this, as seen in FIG. 13, an auxiliary mesh will first be created, which is the head section of the original mesh. To determine which triangles belong to the mesh the triangles need to be classified according on how the t-barycenter sees them (i.e. from the front or from the back) using the dot product of the triangle normal and the vector which goes from the t-barycenter to the triangle. Starting with the seed (which, as it was described before, is the closest triangle found in the intersection of the line which joins the camera position and the center of the facial circle, and the body mesh), the face section is a continuous region of triangles seen from the back. As the shape of the head could include some irregular patterns that will not match with the last criteria to determine the head area of triangles (such a pony tail), it is important to use another system to back the invention method up: using the same information of the head situation in the original photograph, a plane is defined which will be used as a guillotine, rejecting possible non-desired triangles in the head area. Once this new mesh is created, all the vertices will be erased in the cloud mesh, which are not close enough (this distance is determined with the maximum distance from the camera and the head depth, but it could be variable and it is possible to adapt it to different conditions) to this head mesh. Some other cutting planes using the width and height of the model's head that will remove noisy triangles and vertices generated due to possible occlusions will also be defined.

This algorithm does not insert extra information (i.e. vertices or triangles) extracted from the depth map, it only moves existing vertices to a position next to the cloud mesh. As a good triangle resolution in the original mesh is not having, it is important to subdivide the head section of the mesh to obtain a similar resolution to the cloud mesh. For this, Dyn's butterfly scheme is used.

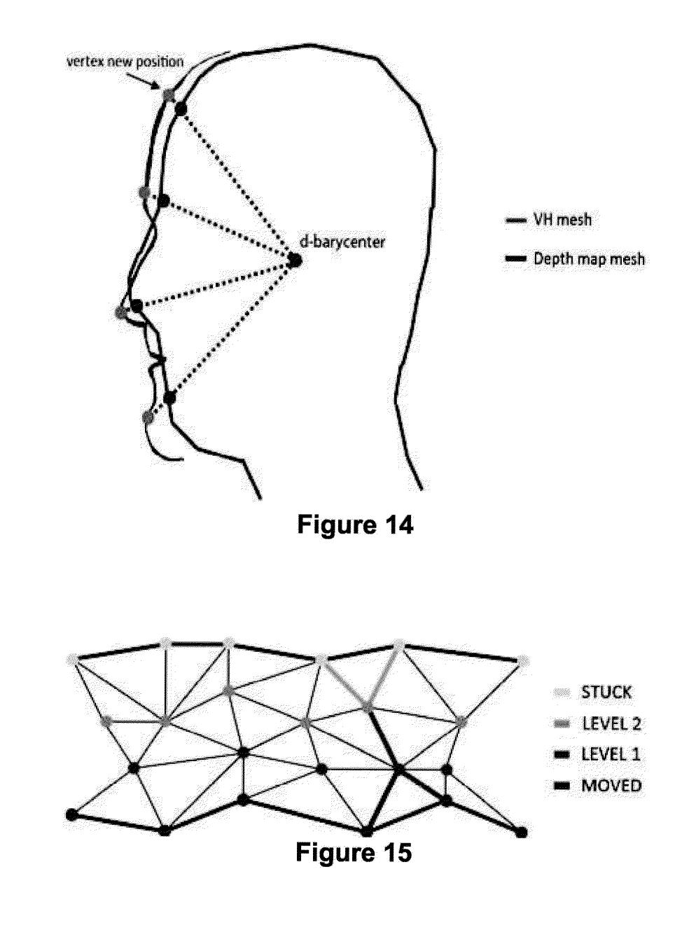

When the section is subdivided, the vertices are ready for moving. The vertices that can potentially be moved are those which have been marked as belonging to the head. The first step of this process consists in tracing lines from the d-barycenter to each of the triangles in the cloud. For each vertex, if the line intersects any remaining cloud triangle, the vertex will be moved to where that intersection takes place and will be marked as MOVED (see FIG. 14).

Then, each of the head vertices (v) is assigned a list, L, which maps a series of MOVED vertices to its distance to v. For example, level one vertex, defined as those which are connected to at least one level zero vertex, have an L list with those level zero vertices they touch and its distance to them. In turn, level two vertices are those which touch at least one level one vertex, and have an L list made up of all the MOVED vertices touched by their level one neighbors. In it, each MOVED vertex is assigned its minimum distance to v. It must take into account that a MOVED vertex can be reached through different “paths”. In this case, it will be chosen the shortest one.

After calculating the L list, it needs to be checked what is called the “distance to the MOVED area” (DMA), which is the minimum of the distances contained in L. If the DMA is greater than a threshold (which can be a function of the depth of the head), the vertex is marked as STUCK instead of being assigned a level, and the L list is no longer needed. Apart from the L list, each vertex with a level greater than zero has a similar list, called LC, with distances to the STUCK vertices.

This way, a zone around the MOVED vertices is obtained, with vertices whose final position will be influenced by both their original one, that of the position of the MOVED vertices in its L list and that of the STUCK vertices in its LC list, so that the transition between the MOVED and the STUCK zones becomes smooth. The way to calculate the new position of the vertices in this area is a linear interpolation of STUCK and MOVED vertices over the line which joins the d-barycenter with the present vertex. The results of calculating the distance form MOVED and STUCK vertices can be seen in FIG. 15.

Texture Mapping

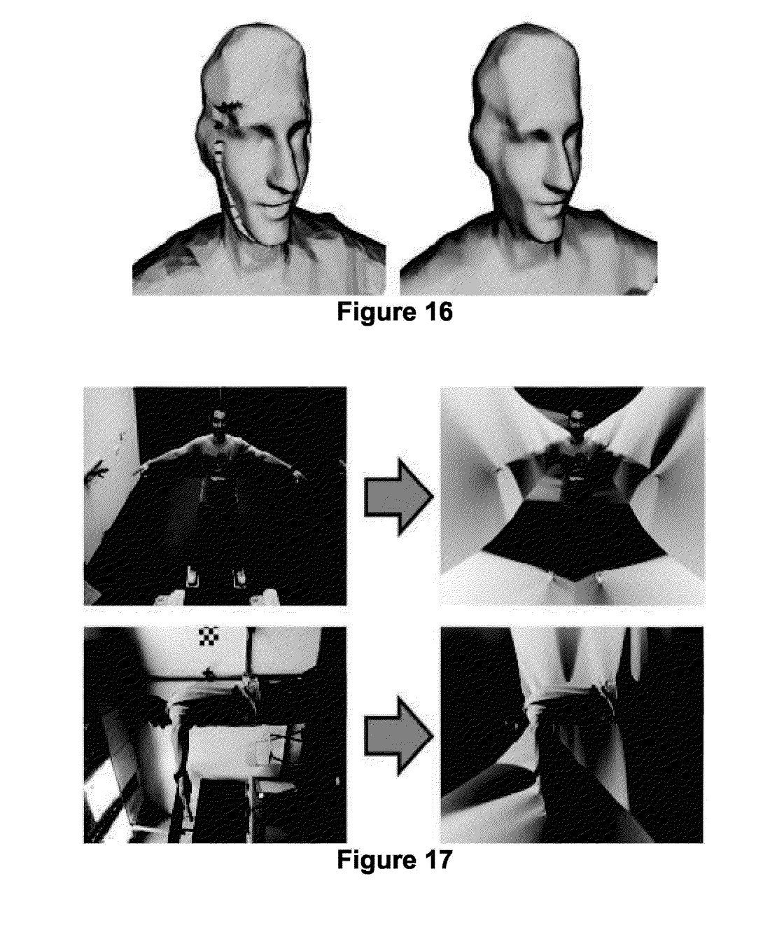

One of the most important processes to add realism to the 3D model is the inclusion of the classic texture mapping, which consists in creating a texture and assigning a pair of texture coordinates to each mesh vertex (see FIG. 16). Usually this texture is manually created by 3D artists. However, in the proposed system the information from the original images taken to the subject is directly employed to texture the 3D mesh in an automatic procedure.

The most intuitive approach would be to rank the different images with a concrete criterion and determine which triangle will be textured with which image. But for transmission/storage frameworks this would be a very inefficient system, because it would be necessary to send/save all the images used for texturing. Systems using this approach usually employ a ranking criterion which depends on the specific view it is trying to render. This leads to view-dependent texturing strategies which are not suitable for some purposes such as 3D printing.

Instead of that, the present invention proposes to create a texture atlas with the information obtained from the images of the subject.

A novel pre-processing step for the captured images which provides robustness to the system against occlusions and mesh inaccuraciesis also included, allowing perceptually correct textures in these zones.

First, input images are pre-processed in order to “expand” foreground information into the background. The objective of this process is to avoid mesh inaccuracies or occlusions to be textured using background information. This is a common problem (especially in setups with a reduced number of cameras) easily detected as an error by human perception. However if small inaccuracies of the volume are textured with colors similar to their neighborhood, it is difficult to detect them, bringing out visually correct models.

Pre-processing can be summarized as follows:

For each image, its input foreground mask is eroded in order to remove any remaining background pixels from the silhouette contour. Then, the inpainting algorithm proposed in [31] is applied in each color image over the area defined by its corresponding eroded mask. This process is carried out modifying only the pixels labeled as background in the original mask (uneroded). Other inpainting techniques may be used for this purpose. FIG. 17 shows two examples of input images and the results after pre-processing them.

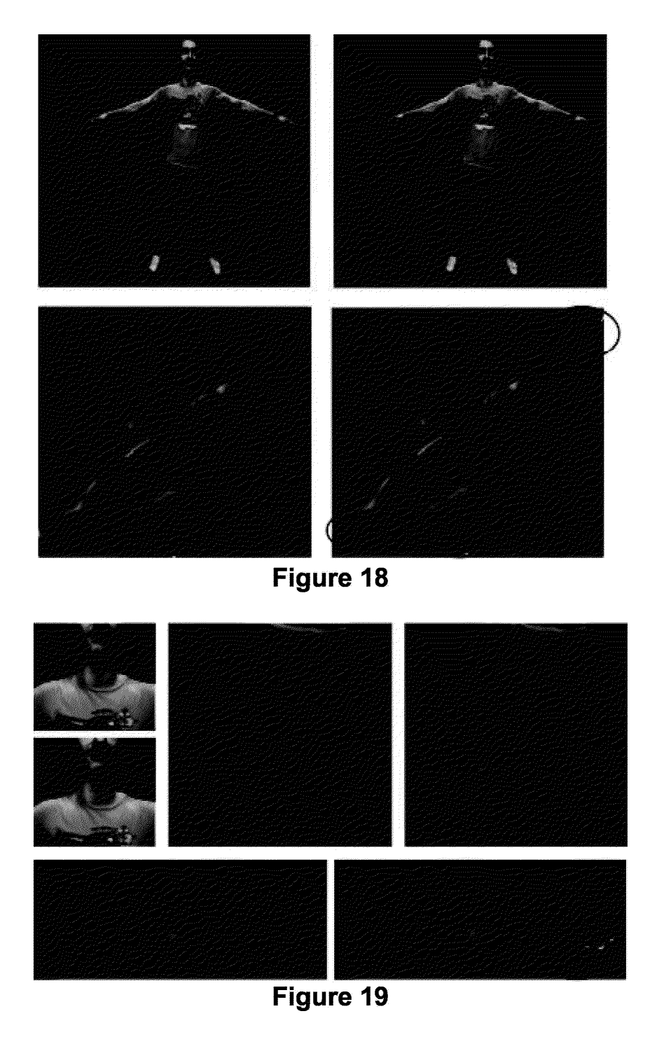

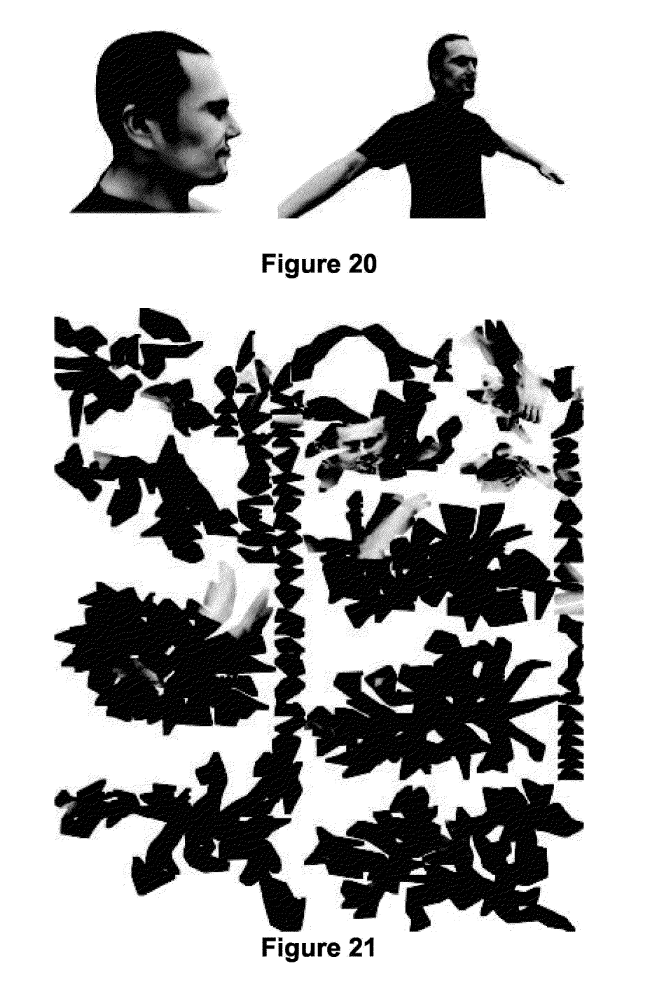

FIG. 18 shows texture improvement by using image pre-processing. Texturing errors which appeared using the original images have been marked by means of red lines. FIG. 19 shows the improved areas in detail. Notice some of the errors are not obvious at first sight because the color of the user's jeans is quite similar to the background.

Pre-processed images are then used to create the texture atlas. In a particular embodiment texture atlas creation may be carried out by using the algorithm described in [25]
The first step is unwrapping the 3D mesh onto 2D patches which represent different areas of the mesh. This unwrapping can be done with some kind of parameterization which normally includes some distortion. However, some zero-distortion approaches exist, where all the triangles in the 2D patches are presented preserving their angles and in proportion to their real magnitude.
The second step consists in packing the 2D patches efficiently to save space. There are many ways to pack these patches but, to simplify the process the bounding boxes of these patches instead of their irregular shape are packed. This problem is known as “NP-hard pants packing” and has been very well studied and used for this scenario.
The third consists in mapping the floating point spatial patch coordinates into integer pixel coordinates (real magnitude into pixels). The user is able to determine the resolution of the texture atlas so it can be designed according to the specifications of the problem.
The fourth and last step is filling the texture atlas with color information. Using the calibration parameters of the cameras, it can be created a rank for every triangle ordering each camera as how well it “sees” the current triangle, and assigning a weight to each camera related with the distance from the triangle. After that, for each vertex of the mesh, another ranking by averaging the weights of the surrounding triangles is obtained. Then it is easy to calculate the composition of weights for each camera in each pixel, by doing a bilinear interpolation of the value of these weights for each vertex of the triangle containing the pixel. The final color information will be a weighted average of the color in each image.

After this process, the results show a smooth-transition texture where seams are not present and there is a big realism. FIG. 21 shows an example of a texture atlas generated with this method.

Rigging and Skinning

Skeletal animation is the most extended technique to animate 3D characters, and it is used in the present invention pipeline to animate the human body models obtained from the 3D reconstruction process. In order to allow skeletal animation, a 3D model must undergo the following steps:

Rigging:The animation of the 3D model, which consists in a polygonal mesh, requires an internal skeletal structure (a rig) that defines how the mesh is deformed according to the skeletal motion data provided. This rig is obtained by a process commonly known as rigging. Therefore, during animation the joints of the skeleton are translated or rotated, according to the motion data, and then each vertex of the mesh is deformed with respect to the closest joints.

Skinning: The process through which the mesh vertices are attached to the skeleton is called skinning. The most popular skinning technique is Linear Blend Skinning (LBS) which associates weights for each of the vertices according to the influence of the distinct joints. The transformation applied to each vertex is a weighted linear combination of the transformations applied to each joint.

Skinning weights must be computed for the vertices of the mesh in a way that allows a realistic result after the LBS deformation performed by a 3D rendering engine. Moreover, the system is required to be compatible with standard human motion capture data, which implies that the internal skeleton cannot have virtual bones in order to improve the animation results, or at least, realistic human body animation should be obtainable without using them. The system introduces a novel articulation model in addition to the human skeleton model in order to provide realistic animations.

In a particular embodiment, rigging can be performed by means of the automatic rigging method proposed in [28] This method provides good results for the skeleton embedding task and successfully resizes and positions a given skeleton to fit inside the character (the approximate skeleton posture must be known). Additionally it can also provide skinning weights computed using a Laplace diffusion equation over the surface of the mesh, which depends on the distance from the vertices to the bones. However, this skinning method acts in the same manner for all the bones of the skeleton. While the resulting deformations for certain joint rotations are satisfactory, for shoulders or neck joints, the diffusion of the vertices weights along the torso and head produce non-realistic deformations. The invention introduces a specific articulation model to achieve realistic animations. The invention skinning system combines Laplace diffusion equation skinning weights (which provides good results for internal joints) and Flexible Skinning weights computed as described in [29] This second skinning strategy introduces an independent flexibility parameter for each joint. The system uses these two skinning strategies in a complementary way. For each joint the adjustment between the two types of skinning and also its flexibility is defined.

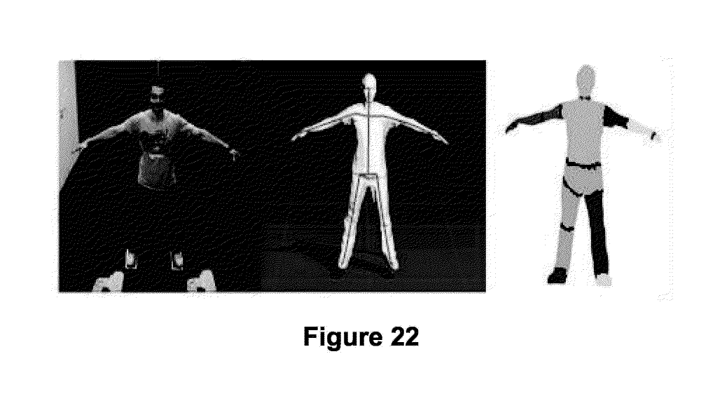

FIG. 22 shows the subject in the capture room (known pose), the mesh with the embedded skeleton and the segmentation of the mesh in different regions associated to skeleton bones (required for flexible skinning).

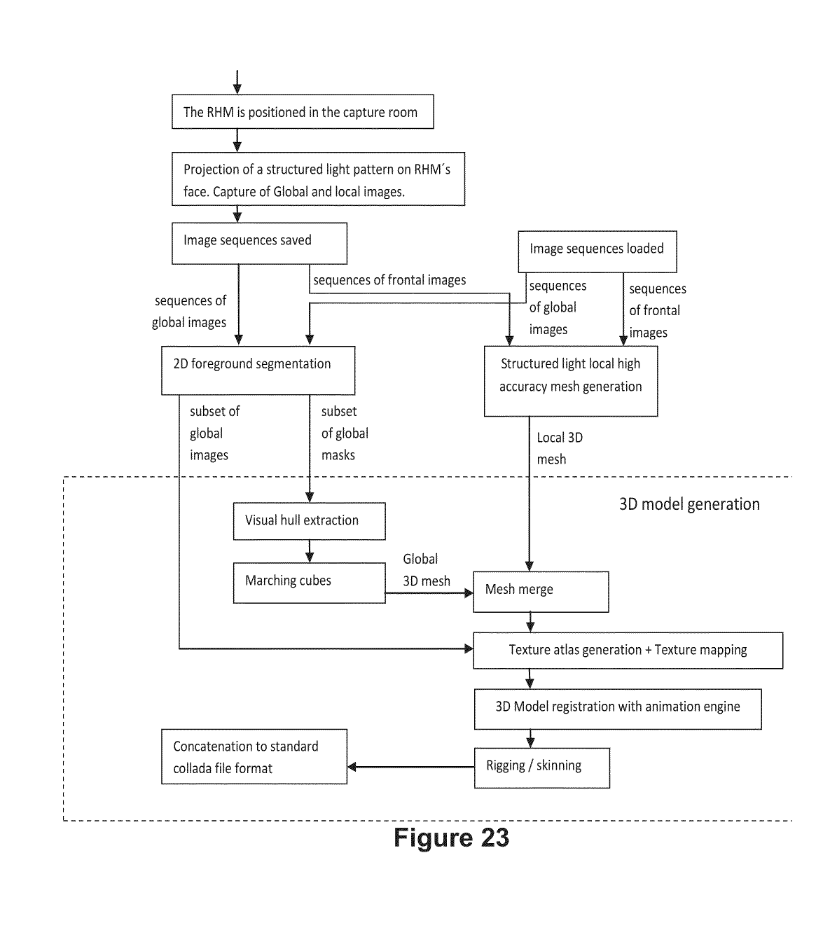

A variation of this invention would be replacing the local mesh generation based on structured light images by an algorithm based on normal local images, according to the flow chart in FIG. 23. This would avoid projecting structured light patterns while acquiring frontal views.

Another variation of this invention would be obtaining the local mesh of the RHM's face with a synthetic 3D face designer

Flow Chart Description:
1. The system is trained. A sequence of images is captured from all peripheral cameras. The room is empty during this process. The training sequences are stored in a temporary directory in capture servers. A background statistical model is computed from these frames for each peripheral camera.
2. The real human model or RHM is positioned in the capture room, in a predefined position.
3. A sequence of images is captured from all peripheral cameras. These sequences are synchronized between them. They are added to the training sequences previously stored. Additionally, a sequence of images is captured from all frontal cameras meanwhile a structured light pattern is projected on the face of the RHM. These sequences are synchronized between them. They are stored in a temporary directory present in the capture servers.
4. At this point, all the information necessary to generate the animatable 3D model is have. On the one hand, it can be grabbed the RHM acquisition in an external storage system, in order to capture other RHMs and carry on the 3D model generation later. On the other hand, it can be load a previously grabbed sequence of images from the external storage system into the capture servers' temporary repositories, to perform a 3D model generation.
5. The sequences of images from the peripheral cameras (global images) are used to perform the foreground segmentation. A subset of synchronized images is chosen by taking one image from each sequence of global images. All global images of the subset correspond to the same time. Then the binary mask depicting the RHM silhouette is computed for the images of this subset.
6. The obtained subset of global masks is used to extract the visual hull of the RHM. A three-dimensional scalar field expressed in voxels is obtained. Then a global 3D polygonal mesh is obtained by applying the marching cubes algorithm to this volume.
7. Meanwhile, the sequences of frontal images obtained with structured light patterns projections are processed to obtain high quality local mesh of the RHM's face.
8. The global mesh is merged with the local mesh in order to obtain a quality improved global mesh.
9. After registering the 3D mesh with the animation engine, rigging and skinning algorithms are applied.
10. Meanwhile, the texture atlas is generated from the subset of global images and the capture room information. This texture atlas is then mapped to the improved and registered 3D mesh.
11. Finally, the rigged and skinned 3D mesh, and the texturized mesh are concatenated to a standard open collada file.

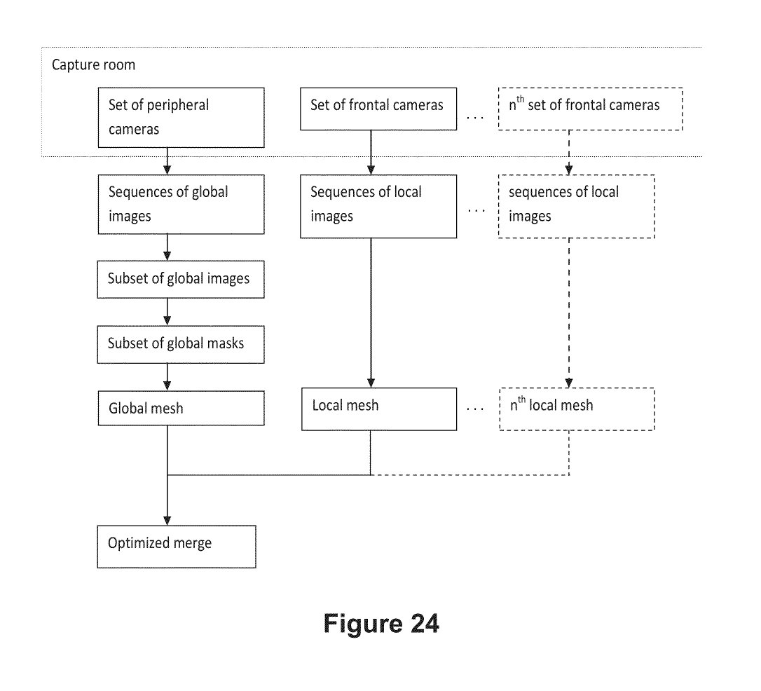

The generation of a high accuracy local mesh of the RHM's face could be applied to a bigger part of the RHM (the bust for example) and/or extended to other parts of the RHM where the 3D reconstruction requires more details. Then the mesh merge process would deform the global mesh according to all the accurate local meshes obtained, as depicted in data flow chart (see FIG. 24).

### ADVANTAGES OF THE INVENTION

The described system proposes a fully automatic pipeline including all the steps from surface capture to animation. The system not only digitally reproduces the model's shape and appearance, but also converts the scanned data into a form compatible with current human animation models in computer graphics.
Hybrid combination of VH information and local structured light provides higher precision and reliability than conventional multi-view stereo systems. Also, resolution of cameras is less critical, as well as color calibration.
Special effort is made in critical areas to allow more metrically accurate reconstructions. Although higher level of detail is provided for the face area, the current 3D modelling framework can be easily extended to improve any critical area of the model.
Mesh merging algorithm is robust against possible polygonal holes in the high polygonal resolution 3D mesh. When this situation occurs, the algorithm interpolates the positions of near vertices to determine the situation of the vertices which would be moved to the hole.
As the system is based on the displacement of existing vertices which have been created by subdividing the previous mesh, it is possible to adapt the final resolution to different storage/transmission scenarios.
The whole system does not need the interaction of the user.
This framework provides a complete model, which includes mesh, texture atlas, rigged skeleton and skinning weights. This allows effortless integration of produced models in current content generation systems.
Skeleton and skinning weights are provided to allow pose deformation. This implies that new content can be generated reusing motion capture information, which is easily retargeted to the provided model.
The system is not limited to free viewpoint video production, in contrast to systems lacking of semantic information such skeleton rig or skinning weights.
Skinning weights can be used in 3D printing applications to automatically generate personalized action figures with different flexibility in articulation joints (materials with different mechanical and physical properties can be used). Also, little further processing would allow placing articulations in the skeleton joints.
Critical areas such as hair are correctly approximated by using silhouette information
Foreground silhouettes are not extracted via chroma-key matting, but using advanced foreground segmentation techniques to avoid the requirement of a chroma-keyed room.
Actor's performance can also be extracted including a tracking step in the pipeline.
Capture hardware is cheaper than current full body laser-scanners [13] and also allows faster user capture process.
Texturing process creates a view-independent texture atlas (no view-dependent texturing is required on rendering time)
Full capture process is performed in a fraction of a second, so there is no need to use complex motion compensation algorithms as the user can remain still.
Background texture expansion process (based on inpainting) provides higher robustness to the texturing process: Visually correct texture atlases are generated even in occluded areas or in zones where the recovered volume is not accurate.

### ACRONYMS

SfS Shape from Silhouette
VH Visual Hull
CAD Computer Assisted Drawing
CGI Computer-Generated Imagery
fps frames per second
VOI Volume Of Interest
HD High Definition
TOF Time Of Flight
RHM Real Human Model
LBS Linear Blend Skinning
VGA Video Graphics Array (640×480 pixels of image resolution)

### REFERENCES

[1] B. Baumgart. Geometric Modeling for Computer Vision. PhD thesis, Stanford University, 1974.
[2] W. E. Lorensen and H. E. Cline. Marching cubes: A high resolution 3d surface construction algorithm. In SIGGRAPH'87, volume 21, pages 163-169,1987
[3] J. Starck and A. Hilton. Surface Capture for Performance-Based Animation. IEEE Computer Graphics and Applications (CG&A), 2007
[4] G. Vogiatzis, C. Hernández, P. H. S. Torr, and R. Cipolla. Multi-view Stereo via Volumetric Graph-cuts and Occlusion Robust Photo-Consistency. IEEE Transactions in Pattern Analysis and Machine Intelligence (PAMI), vol. 29, no. 12, pages 2241-2246, December 2007.
[5] Yasutaka Furukawa and Jean Ponce. Carved Visual Hulls for Image-Based Modeling. International Journal of Computer Vision, Volume 81, Issue 1, Pages 53-67, March 2008
[6] Heinrich Müller and Michael Wehle, Visualization of Implicit Surfaces Using Adaptive Tetrahedrizations, Scientific Visualization Conference (dagstuhl '97), 1997
[7] C. Hernández and F. Schmitt. Silhouette and Stereo Fusion for 3D Object Modeling. Computer Vision and Image Understanding, Special issue on “Model-based and image-based 3D Scene Representation for Interactive Visualization”, vol. 96, no. 3, pp. 367-392, December 2004.
[8] Yongjian Xi and Ye Duan. An Iterative Surface Evolution Algorithm for Multiview Stereo. EURASIP Journal on Image and Video Processing. Volume 2010 (2010).
[9] S. Seitz, B. Curless, J. Diebel, D. Scharstein, and R. Szeliski. A comparison and evaluation of multi-view stereo reconstruction algorithms. Proceedings of IEEE Computer Society Conference on Computer Vision and Pattern Recognition (CVPR '06), vol. 1, pp. 519-526, July 2006.
[10] 4D View Solutions: Real-time 3D video capture systems. http://www.4dviews.com/
[11] Hilton, A., Starck, J., Collins, G.: From 3D Shape Capture to Animated Models. In: Proceedings of First International Symposium on 3D Data Processing Visualization and Transmission, pp. 246-255 (2002)
[12] Aguiar, E., Zayer, R., Theobalt, C., Magnor, M., Seidel, H.P.: A Framework for Natural Animation of Digitized Models. MPI-I-2006-4-003 (2006)
[13] Cyberware Rapid 3D Scanners http://www.cyberware.com/
[14] J. Salvi, S. Fernandez, T. Pribanic, X. Llado. A State of the Art in Structured Light Patterns for Surface Profilometry. Pattern Recognition 43(8), 2666-2680, 2010.
[15] K. Müller, A. Smolic, B. Kaspar, P. Merkle, T. Rein, P. Eisert and T. Wiegand, “Octree Voxel Modeling with Multi-View Texturing in Cultural Heritage Scenarios”, Proc. WIAMIS 2004, 5th International Workshop on Image Analysis for Multimedia Interactive Services, London, April 2004.
[16] J. Starck, G. Miller and A. Hilton. Video-Based Character Animation. ACM SIGGRAPH Symposium on Computer Animation (SCA), 2005
[17] J. I. Ronda, A. Valdés, G. Gallego, “Line geometry and camera autocalibration”, Journal of Mathematical Imaging and Vision, vol. 32, no. 2, pp. 193-214, October 2008.
[18] Heinrich Müller, Michael Wehle, “Visualization of Implicit Surfaces Using Adaptive Tetrahedrizations,” dagstuhl, pp. 243, Scientific Visualization Conference (dagstuhl '97), 1997
[19] J. Vollmer and R. Mencl and H. Muller. Improved Laplacian smoothing of noisy surface meshes. Computer Graphics Forum, pp 131-138, 1999.
[20] M. Garland and P. S. Heckbert. Surface simplification using quadric error metrics. In SIGGRAPH '97: Proceedings of the 24th annual conference on Computer graphics and interactive techniques, pages 209-216, New York, N.Y., USA, 1997. ACM Press/Addison-Wesley Publishing Co.
[21] L. S. Tekumalla and E. Cohen. A hole-filling algorithm for triangular meshes. School of Computing, University of Utah UUCS-04-019, UT, USA. 2004.
[22] C. Y. Chen, K. Y. Cheng and H. Y. M. Liao. A Sharpness Dependent Approach to 3D Polygon Mesh Hole Filling. Proceeding of Eurographics. 2005.
[23] W. Zhao, S. Gao, H. Lin. A robust hole-filling algorithm for triangular meshes. The Visual Computer, vol. 23, num. 12, pp. 987-997. 2007.
[24] Y. Yu, K. Zhou, D. Xu, X. Shi, H. Bao, B. Guo and H. Y. Shum. Mesh Editing with Poisson-Based Gradient Field Manipulation. ACM Transaction on Graphics, vol. 23, num. 3, pp. 644-651. 2004.
[25] R. Pagés, S. Arnaldo, F. Morán and D. Berjón. Composition of texture atlases for 3D mesh multi-texturing. Proceedings of the Eurographics Italian Chapter EG-IT'10, pp. 123-128. 2010.
[26] Congote, John Edgar, Barandian, Iñigo, Barandian, Javier and Nieto, Marcos (2011), “Face Reconstruction with structured light” in Proccedings of Visapp 2011, International Conference on Computer Vision and Application, Algarbe, Portugal
[27] Montserrat, Tomas, Civit, Jaume, Divorra, Oscar and Landabaso, Jose Luis (2009), “Depth Estimation Based on Multiview Matching with Depth/Color Segmentation and Memory Efficient Belief Propagation”.
[28] I. Baran and J. Popovic. Automatic rigging and animation of 3d characters. In ACM SIGGRAPH 2007 papers, page 72. ACM, 2007.
[29] F. Hétroy, C. Gérot, Lin Lu, and Boris Thibert. Simple flexible skinning based on manifold modeling. In International Conference on Computer Graphics Theory and Applications, GRAPP 2009, pages 259-265, 2009
[30] J. Gallego, M. Pardas, and G. Haro. Bayesian foreground segmentation and tracking using pixel-wise background model and region based foreground model. In Proc. IEEE Int. Conf. on Image Processing, 2009
[31] Alexandru Telea. An Image Inpainting Technique Based on the Fast Marching Method. Journal of graphics, gpu, and game tools”, volume 9, number 1, pages 23-34, 2004

1. A method for generating a realistic 3D reconstruction model for an object or being, comprising:
a) capturing a sequence of images of an object or being from a plurality of surrounding cameras;
b) generating a mesh of said an object or being from said sequence of images captured;
c) creating a texture atlas using the information obtained from said sequence of images captured of said object or being;
d) deforming said generated mesh according to higher accuracy meshes of critical areas;and
e) rigging said mesh using an articulated skeleton model and assigning bone weights to a plurality of vertices of said skeleton model;
wherein the method is characterized in that it further comprises generating said 3D reconstruction model as an articulation model further using semantic information enabling animation in a fully automatic framework.

2. The method of claim 1, wherein said step a) is performed in a capture room.

3. The method of claim 2, comprising regulating said plurality of surrounding cameras under controlled local structured light conditions.

4. The method of claim 3, wherein said plurality of surrounding cameras are synchronized.

5. The method of claim 1, wherein said model is a closed and manifold mesh generated by means of at least one of a: Shape from Silhouette techniques, Shape from Structured light techniques, Shape from Shading, Shape from Motion or any total or partial combination thereof.

6. The method of claim 5, comprising obtaining a three-dimensional scalar field, represented in voxels, of a volume of said mesh or model.

7. The method of claim 6, further comprising applying multi-view stereo methods for representing critical areas with higher detail of objects or beings.

8. The method of claim 7, comprising using a local high density mesh for representing said critical areas.

9. The method of claim 8, wherein said local high density mesh is based on shape from structured light techniques.

10. The method of claim 8, wherein said local high density mesh uses an algorithm based on depth maps.

11. The method of claim 8, further comprising using said local high density mesh with a synthetic 3D model.

12. The method of claim 8, comprising merging said generating mesh of said step b) and said local high density mesh by means of obtaining a quality improved global mesh.

13. The method of claim 1, wherein said information used for creating said texture atlas in said step c) is directly employed to texture said mesh.

14. The method of claim 13, further comprising a pre-processing step for said sequence of images captured.

15. The method of claim 14, wherein said information used for creating said texture atlas comprises information concerning the colour of said sequence of images.

16. The method of claim 1, wherein said assigned bone weights to said plurality of vertices of said skeleton model in said step e) further comprises using a combination of a Laplace diffusion equation and a Flexible Skinning weight method.

17. The method of claim 1, comprising concatenating said rigged and weighted mesh and said texturized mesh by means of being used in a compatible CAD application.

18. The method of claim 1, wherein said object or being reconstruction model comprises a human model.

19. A system for generating a realistic 3D reconstructionmodel for an object or being, comprising:
a capture room equipped with a plurality of cameras surrounding an object or being to be scanned; and
a plurality of capture servers for storing images of said object or being from said plurality of cameras,
characterized in that said images of said object or being are used for fully automatically generate said 3D reconstruction model as an articulation model.

20. The system of claim 19, wherein said system implementing a method according to any of the previous claims.

21. The system of claim 19, wherein said capture room is equipped with a plurality of pheripheral cameras arrange to reconstruct a Visual Hull (VH) of said object or being scanned.

22. The system of claim 19, wherein said capture room is equipped with a plurality of local cameras arranged to obtain a high quality local mesh for critical areas of said object or being scanned.

23. The system of claim 22, comprising a structured light pattern arranged to project on said object or being to be scanned.

24. The system of claim 19, wherein said object or being is a human or living being.
